(19) United States
(12) Patent Application Publication
(10) Pub. No.: US 2024/0320583 A1
(43) Pub. Date: Sep. 26, 2024

(54) Workflow optimization systems

(71) Applicant: David Noll, Louisviller, KY (US)

(72) Inventor: David Noll, Louisviller, KY (US)

(21) Appl. No.: 18/608,110

(22) Filed: Mar. 18, 2024

Related U.S. Application Data
(60) Provisional application No. 63/491,476, filed on Mar. 21, 2023.

(51) Int. Cl. G06Q 10/0631

(52) U.S. Cl. CPC G06Q 10/06316; G06Q 10/06312

(57) ABSTRACT

Described herein are examples of methods which include representing tasks within a workflow using a network of nodes, where each node includes one or more interconnected subtasks associated with their respective node and metadata. Additionally, the method may include evaluating, via a task assessment module, the interconnected subtasks based on a predetermined variable and a user input. The method may also include generating instructions for task execution based on the evaluation of the nodes and executing the instructions using a processor to determine at least one task to be performed by a user in the workflow. The method may further include providing a user interface to receive the user input and display the network of nodes.

### CROSS-REFERENCE TO RELATED APPLICATIONS

The present application claims the benefit of U.S. Provisional Patent Application No. 63/491,476 entitled “VISUAL PROGRAMMING LANGUAGE DESIGNED FOR EXECUTION OF HUMAN CHECKLISTS BY HUMAN, COMPUTER, OR OTHER AGENTS”, filed on Mar. 21, 2023. The entire contents of the above-listed application are hereby incorporated by reference for all purposes.

### BACKGROUND

A task management system is used to enhance workflow efficiency and collaboration. It includes various components such as task dependency tracking, resource allocation algorithms, and decision-making tools. By utilizing various algorithms and graph structures, the system enables users to manage complex workflows effectively, optimize resource utilization, and facilitate communication among team members. Additionally, interactive visualization tools integrated into the user interface may enhance user productivity.

### BRIEF DESCRIPTION OF THE DRAWINGS

The present description will be understood more fully when viewed in conjunction with the accompanying drawings of various examples of workflow optimization systems. The description is not meant to limit the workflow optimization system to the specific examples. Rather, the specific examples depicted and described are provided for explanation and understanding of workflow optimization systems. Throughout the description the drawings may be referred to as drawings, figures, and/or FIGs.

FIG. 1 illustrates a workflow optimization system, according to an embodiment.

FIG. 2 illustrates a device schematic for various devices used in a workflow optimization system, according to an embodiment.

FIG. 3 is a block diagram of a workflow optimization system, according to an embodiment.

FIG. 4 representatively illustrates a data structure of a node within a nodal network of a workflow optimization system, according to an embodiment.

FIG. 5 illustrates a flow diagram depicting the operation of an algorithm for determining an order for executing tasks within a workflow, according to an embodiment.

FIG. 6 representatively illustrates a workflow optimization system, according to an embodiment.

FIG. 7 is a flow diagram for the evaluation of a node within a nodal network of a workflow optimization system, according to an embodiment.

FIG. 8 is a flow diagram illustrating a workflow optimization method, according to an embodiment.

### DETAILED DESCRIPTION

A workflow optimization system as disclosed herein will become better understood through a review of the following detailed description in conjunction with the figures. The detailed description and figures provide merely examples of the various embodiments of workflow optimization systems. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

A conventional task management application may include a basic interface where users can input and organize tasks by priority, due date, or project. These applications typically lack features for managing complex workflows, such as tracking task dependencies, allocating resources, and enabling collaboration among team members. Instead, users often rely on manual processes to manage task dependencies and allocate resources, leading to inefficiencies and potential errors in task execution. Moreover, conventional systems do not provide intelligent recommendations or automated support for decision-making and therefore typically require users to depend solely on their judgment and experience.

The current state of the art in task management applications presents challenges and opportunities. One challenge is the lack of flexibility to handle diverse workflows with interconnected tasks and dependencies. Users often struggle to efficiently manage complex projects with changing requirements and resource constraints. Additionally, memory allocation and resource allocation pose significant challenges, leading to performance issues and potential system slowdowns. These problems exacerbate the challenges in current task management applications. Conventional systems may struggle to efficiently allocate memory resources, resulting in performance issues and system slowdowns, especially when handling large datasets or complex workflows. Inadequate resource allocation can also lead to delays or incomplete task execution, affecting productivity and project outcomes. However, a task management system that includes various algorithms that dynamically adjust resource allocation based on task priorities and dependencies can address these memory and resource allocation challenges.

Implementations of task management systems may address some or all of the problems described above. A task management system may include components or features such as task dependency tracking, dynamic resource allocation algorithms, and collaborative decision-making components. By utilizing various algorithms and graph structures, these systems can efficiently manage complex workflows, optimize resource utilization, and enable effective communication and collaboration among team members. Additionally, the task management system may include user interfaces with interactive visualization tools.

The disclosed embodiments of task management systems address various challenges encountered in conventional tools by incorporating, among other things, nodal networks such as graph structures and various algorithms to enable users to efficiently manage complex workflows, allocate resources effectively, and make informed decisions based on recommendations. Collaborative features such as voting mechanisms and discussion threads may also be integrated into the system to enable team collaboration and decision-making, which in turn enhances productivity. Moreover, by dynamically adjusting resource allocation based on task priorities and dependencies, the disclosed embodiments help optimize workflow processes and mitigate the impact of memory and resource allocation challenges present in the current state of the art.

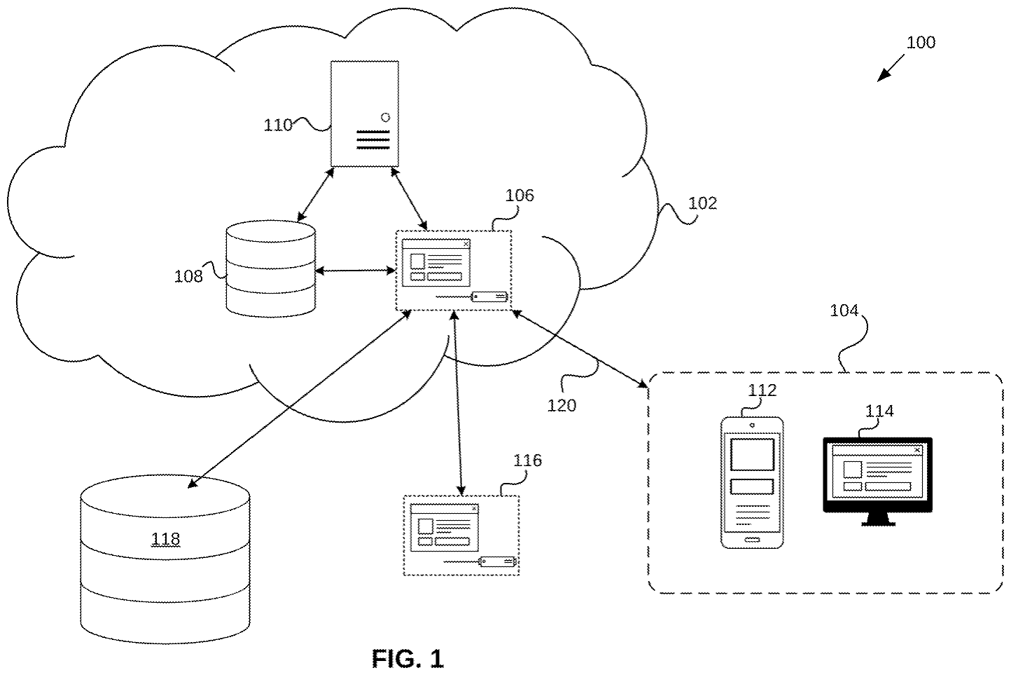

FIG. 1 illustrates a workflow optimization system 100, according to an embodiment. The workflow optimization system 100 includes internal and external data resources for enhancing workflow efficiency and collaboration and managing a project. The workflow optimization system 100 may result in reduced memory allocation at client devices and may conserve memory resources for application servers.

The workflow optimization system 100 may include a cloud-based data management system 102 and a user device 104. The cloud-based data management system 102 may include an application server 106, a database 108, and a data server 110. The user device 104 may include one or more devices associated with user profiles of the workflow optimization system 100, such as a smartphone 112 and/or a personal computer 114. The workflow optimization system 100 may include external resources such as an external application server 116 and/or an external database 118. The various elements of the workflow optimization system 100 may communicate via various communication links 120. An external resource may generally be considered a data resource owned and/or operated by an entity other than an entity that utilizes the cloud-based data management system 102 and/or the user device 104.

The workflow optimization system 100 may be web-based. The user device 104 may access the cloud-based data management system 102 via an online portal set up and/or managed by the application server 106. The workflow optimization system 100 may be implemented using a public internet. The workflow optimization system 100 may be implemented using a private intranet. Elements of the workflow optimization system 100, such as the database 108 and/or the data server 110, may be physically housed at a location remote from an entity that owns and/or operates the workflow optimization system 100. For example, various elements of the workflow optimization system 100 may be physically housed at a public service provider such as a web services provider. Elements of the workflow optimization system 100 may be physically housed at a private location, such as at a location occupied by the entity that owns and/or operates the workflow optimization system 100.

The communication links 120 may be direct or indirect. A direct link may include a link between two devices where information is communicated from one device to the other without passing through an intermediary. For example, the direct link may include a Bluetooth™ connection, a Zigbee® connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links 120, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long-term evolution (LTE) standard, and so forth. “Indirect,” when used regarding the communication links 120, may refer to any of the aforementioned indirect communication links.

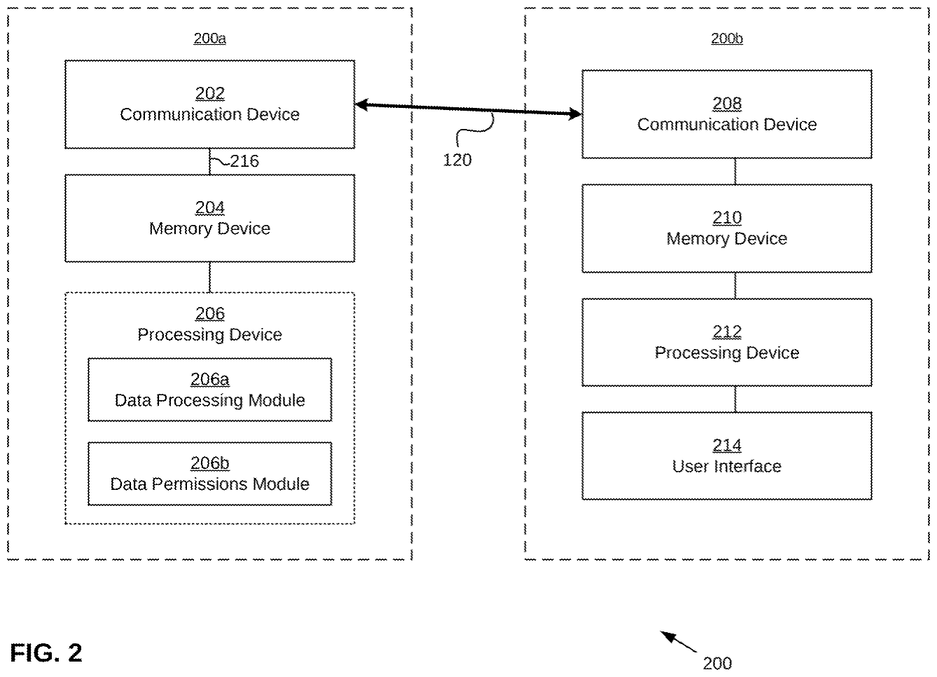

FIG. 2 illustrates a device schematic 200 for various devices used in the workflow optimization system 100, according to an embodiment. A server device 200a may moderate data communicated to a client device 200b based on data permissions to minimize memory resource allocation at the client device 200b.

The server device 200a may include a communication device 202, a memory device 204, and a processing device 206. The processing device 206 may include a data processing module 206a and a data permissions module 206b, where module refers to specific programming that governs how data is handled by the processing device 206. The client device 200b may include a communication device 208, a memory device 210, a processing device 212, and a user interface 214. Various hardware elements within the server device 200a and/or the client device 200b may be interconnected via a system bus 216. The system bus 216 may be and/or include a control bus, a data bus, and address bus, and so forth. The communication device 202 of the server device 200a may communicate with the communication device 208 of the client device 200b.

The data processing module 206a may handle inputs from the client device 200a. The data processing module 206a may cause data to be written and stored in the memory device 204 based on the inputs from the client device 200b. The data processing module 206a may retrieve data stored in the memory device 204 and output the data to the client device 200a via the communication device 202. The data permissions module 206b may determine, based on permissions data stored in the memory device, what data to output to the client device 200b and what format to output the data in (e.g. as a static variable, as a dynamic variable, and so forth). For example, a variable that is disabled for a particular user profile may be output as static. When the variable is enabled for the particular user profile, the variable may be output as dynamic.

The server device 200a may be representative of the cloud-based data management system 102. The server device 200a may be representative of the application server 106. The server device 200a may be representative of the data server 110. The server device 200a may be representative of the external application server 116. The memory device 204 may be representative of the database 108 and the processing device 206 may be representative of the data server 110. The memory device 204 may be representative of the external database 118 and the processing device 206 may be representative of the external application server 116. For example, the database 108 and/or the external database 118 may be implemented as a block of memory in the memory device 204. The memory device 204 may further store instructions that, when executed by the processing device 206, perform various functions with the data stored in the database 108 and/or the external database 118.

Similarly, the client device 200b may be representative of the user device 104. The client device 200b may be representative of the smartphone 112. The client device 200b may be representative of the personal computer 114. The memory device 210 may store application instructions that, when executed by the processing device 212, cause the client device 200b to perform various functions associated with the instructions, such as retrieving data, processing data, receiving input, processing input, transmitting data, and so forth.

As stated above, the server device 200a and the client device 200b may be representative of various devices of the workflow optimization system 100. Various of the elements of the workflow optimization system 100 may include data storage and/or processing capabilities. Such capabilities may be rendered by various electronics for processing and/or storing electronic signals. One or more of the devices in the workflow optimization system 100 may include a processing device. For example, the cloud-based data management system 102, the user device 104, the smartphone 112, the personal computer 114, the external application server 116, and/or the external database 118 may include a processing device. One or more of the devices in the workflow optimization system 100 may include a memory device. For example, the cloud-based data management system 102, the user device 104, the smartphone 112, the personal computer 114, the external application server 116, and/or the external database 118 may include the memory device.

The processing device may have volatile and/or persistent memory. The memory device may have volatile and/or persistent memory. The processing device may have volatile memory and the memory device may have persistent memory. Memory in the processing device may be allocated dynamically according to variables, variable states, static objects, and permissions associated with objects and variables in the workflow optimization system 100. Such memory allocation may be based on instructions stored in the memory device. Memory resources at a specific device may be conserved relative to other systems that do not associate variables and other object with permission data for the specific device.

The processing device may generate an output based on an input. For example, the processing device may receive an electronic and/or digital signal. The processing device may read the signal and perform one or more tasks with the signal, such as performing various functions with data in response to input received by the processing device. The processing device may read from the memory device information needed to perform the functions. For example, the processing device may update a variable from static to dynamic based on a received input and a rule stored as data on the memory device. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processing device.

The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory device.

Various of the devices in the workflow optimization system 100 may include data communication capabilities. Such capabilities may be rendered by various electronics for transmitting and/or receiving electronic and/or electromagnetic signals. One or more of the devices in the workflow optimization system 100 may include a communication device, e.g., the communication device 202 and/or the communication device 208. For example, the cloud-based data management system 102, the user device 104, the smartphone 112, the personal computer 114, the application server 116, and/or the external database 118 may include a communication device.

The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth™ programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the aforementioned elements and/or features of the communication component.

Various of the elements in the workflow optimization system 100 may be referred to as a “server.” Such elements may include a server device. The server device may include a physical server and/or a virtual server. For example, the server device may include one or more bare-metal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

Various of the devices in the workflow optimization system 100, including the server device 200a and/or the client device 200b, may include a user interface for outputting information in a format perceptible by a user and receiving input from the user, e.g., the user interface 214. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

Various methods are described below. The methods may be implemented by the data analysis system 100 and/or various elements of the data analysis system described above. For example, inputs indicated as being received in a method may be input at the client device 200b and/or received at the server device 200a. Determinations made in the methods may be outputs generated by the processing device 206 based on inputs stored in the memory device 204. Correlations performed in the methods may be executed by the correlation module 206a. Inference outputs may be generated by the inference module 206b. Key data and/or actionable data may be stored in the knowledge database 204b. Correlations between key data and actionable data may be stored in the knowledge database 204b. Outputs generated in the methods may be output to the output database 204c and/or the client device 200b. In general, data described in the methods may be stored and/or processed by various elements of the data analysis system 100.

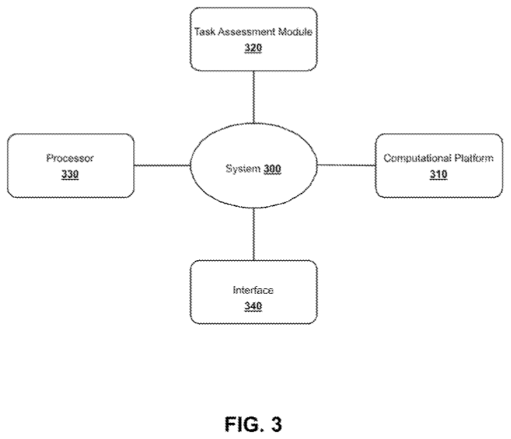

FIG. 3 is a block diagram of workflow optimization system 300, according to an embodiment. The system 300 may dynamically assess a workflow and determine the next optimal step based on predefined conditions and user input. The system 300 may enable efficient task management, progress tracking, resource allocation, and decision-making throughout the entire lifecycle of a workflow. Additionally, the system 300 may reduce processing overhead and resource waste and enhance the productivity of the computer processes running the application on which the system 300 is implemented. In various embodiments, the system 300 may include a computational platform 310, a task assessment module 320, a processor 330, and a user interface 340.

The computational platform 310 may include a network of nodes, such as a graph structure, to organize and manage tasks within a workflow. In an embodiment, the graph structure may include a hierarchical arrangement resembling a tree-like structure. The graph structure may consist of a plurality of nodes, each representing a distinct task or subtask, along with one or more interconnected subtasks associated with the respective task of the node. For example, in a project management scenario, various tasks such as ‘Design User Interface,’ ‘Write Code,’ and ‘Test Functionality’ could be interconnected subtasks under a parent task called ‘Develop Software Application.’ Within this framework, each node, along with its associated parent task, may include a set of alternative tasks. Each alternative task may have its own set of dependent tasks, such that the performance of a first task associated with a first node is dependent on the performance of a second task associated with a second node within the same graph structure, or the performance of a first interconnected subtask associated with the first node is dependent on the performance of a second subtask associated with the first node. Similarly, the performance of the first interconnected subtask associated with the first node may be dependent on the performance of a third subtask associated with the second node. Multiple variations on node dependencies may be implemented depending on the complexity of the workflow.

Within the graph structure, each node may contain metadata. The metadata may include detailed technical information for use by other components of the system 300 for effective task execution and evaluation within the graph structure, such as determining which tasks or subtasks to complete in a given order. The metadata may include various technical details, such as estimates of lines of code, specific programming language requirements, and dependencies on other tasks. Dependencies may be encoded via the metadata, which may include referencing the addresses of other nodes and specifying the nature of their relationship with a particular node. Furthermore, the metadata may contain probabilistic assessments that indicate the likelihood of successfully completing a workflow, task, or subtask based on various factors such as complexity ratings. Additionally, cost-related information, such as estimated budget requirements to complete all the tasks within a given workflow or a particular subgraph or subtask within the workflow, may also be included in the metadata. The metadata may be stored with each node by associating it directly with the node's data structure, such as by including metadata fields within the node object or structure itself. This may allow for easy access and manipulation of the metadata when a component of the system 300 interacts with the node. The metadata may be generated with an artificial intelligence system or module, such as Chat GPT, by using available contextual information, previously added metadata, or metadata from the nodes dependencies, or its “parent” nodes. By generating a prompt for a GPT module recursively from the subtasks that compose a larger task, more accurate or context-appropriate metadata can be generated than would be possible by prompting in a more defined way. It may similarly be generated via other AI architectures or automated processes.

The task assessment module 320 may be connected to various components of the system 300 depending on how it is implemented. If integrated into the computational platform 310 itself, the task assessment module 320 may be directly coupled to or interact with the computational platform's resources and processing capabilities. Specifically, in this embodiment, the task assessment module 320 may be integrated with the platform's architecture to enable access to task-related metadata and dependencies stored within the system 300. In another embodiment where the task assessment module 320 is implemented as a separate component, the task assessment module 320 may be communicatively linked to the computation platform 310 via various interfaces or protocols such that it can retrieve necessary data for evaluating the workflow, tasks, or subtasks. Additionally, the task assessment module 320 may be coupled to or interact with other system components such as databases, external storage devices, or user interfaces to gather relevant information and provide feedback on task evaluations. Regardless of its implementation, the task assessment module 320 may utilize the computational platform 310 to access computing resources and processing power to perform its functions as described herein. Examples of hardware devices on which the task assessment module could be implemented include central processing units (CPUs), graphics processing units (GPUs), field-programmable gate arrays (FPGAs), application-specific integrated circuits (ASICs), and similar computing devices capable of executing algorithms and processing tasks.

The task assessment module 320 may automatically or manually evaluate tasks or subtasks, regardless of their interconnection, based on predefined or dynamically provided conditions to determine the next step for a user or the optimal workflow order, generating instructions such as rewrite instructions accordingly. The conditions can change over time in response to certain events or can be fixed or static. Predefined conditions, such as a task dependency, a task priority, an input type requirement, a time constraint, a resource requirement, an approval requirement, a cost requirement, a risk assessment, a performance metric, or the like, can be integrated into or provided to the system 300 through various configuration settings or user input. In this regard, the task assessment module 320 may be configured to receive and utilize inputs from various sources, including human evaluators, automated systems, user groups, or sensors/IoT devices, in its assessment of the workflow nodes, after which it generates the rewrite instructions. For instance, in a manufacturing environment, real-time data from IoT devices monitoring machinery may be gathered. By utilizing this input, the task assessment module 320 may dynamically allocate resources, generate instructions for task execution, and optimize production schedules within the workflow.

Additionally, the task assessment module 320 may evaluate the graph structure by analyzing predefined conditions along with metadata or supplementary data associated with each node. The task assessment module 320 may process metadata linked with each node to identify the next step in a workflow based on various factors such as programming language requirements, task dependencies, and probabilistic assessments. For example, in a software development project, the algorithm could analyze tasks like coding, testing, and deployment by traversing the graph structure, gathering data from each node and subtask, including task dependencies retrieved from metadata or supplementary data associated with the nodes. It may also identify dependencies, such as the deployment task relying on the completion of coding and testing tasks. The task assessment module 320 may assign weights to tasks or subtasks based on factors like dependencies, priority, and estimated completion time. A weighted sum algorithm may then be utilized to calculate the overall score for each task or subtask, with the highest-scoring one considered the next step to be performed in the workflow.

For instance, the task assessment module 320 may compute a rank score for each node within the workflow based on predefined criteria and user input. To calculate the rank score, the system employs a formula that combines the weighted values of the criteria by assigning relative importance to each criterion. The formula for computing the rank score may be as follows:

$$Rank Score = ( w 1 * Criteria 1 ) + ( w 2 * Criteria 2 ) + … + ( wn * Criterion )$$

In this formula, w1, w2, . . . , wn represent the weights assigned to each criterion, reflecting their significance in determining the overall rank score. Criteria1, Criteria2, . . . , Criterion denote the values obtained from the predefined criteria and user input for each criterion.

Once the rank scores are computed for all nodes within the workflow, the system ranks the tasks for execution order based on these scores. Nodes with higher rank scores may be prioritized for execution over nodes with lower rank scores. This ranking process may result in tasks being executed in an order that optimally aligns with the predefined criteria and user preferences, which in turn enhances workflow efficiency.

Alternatively, the task assessment module 320 may utilize probabilistic assessments to estimate the likelihood of success for each task or subtask and prioritize those with higher probabilities. The task assessment module 320 may also prioritize tasks that can be completed with available resources if specific resources are unavailable for certain tasks. Furthermore, the task assessment module 320 may continuously or dynamically analyze the current state of the graph structure and generate rewrite instructions in real-time. The rewrite instructions may instruct another component, such as the processor 330, on how the graph structure should be adjusted or updated during evaluation and can include instructions to add or remove connections between nodes and update properties, such as node IDs, metadata, supplementary data, and the like. Moreover, the instructions may be customized for different evaluators and node values by the processor 330, which may, in conjunction with the task assessment module 320, evaluate the graph structure's state and evaluator types to determine suitable actions based on the predefined conditions.

The algorithm utilized by the task assessment module 320 may weigh various factors or variables and evaluate various aspects of the workflow to make informed decisions rather than making arbitrary choices. For example, when using a depth-first search (DFS) traversal algorithm, the system may consider factors or variables such as task dependencies, complexity ratings, deadlines, resource availability, and task priority. By traversing the graph structure and analyzing these factors or variables, the algorithm determines the most suitable next step(s) in the workflow. Similarly, if Kahn's algorithm is utilized, the system may prioritize tasks based on their dependencies and optimize resource allocation accordingly. This may include analyzing the graph structure to identify tasks with fewer dependencies, which can be executed more efficiently, thus reducing resource contention and improving workflow performance. Furthermore, the algorithm may utilize heuristics or predefined rules to guide decision-making. For example, it may prioritize tasks with imminent deadlines or allocate resources based on critical path analysis. Additionally, by caching intermediate results and avoiding redundant calculations, the algorithm may optimize computational efficiency, resulting in faster and more accurate decisions. Accordingly, the algorithm used by the task assessment module 320 may evaluate multiple variables, weigh the significance of each, and apply predefined criteria to make decisions regarding the next steps to be performed in the workflow.

The task assessment module 320 may be further configured to identify trends within the workflow by analyzing various parameters and relationships between tasks. The task assessment module 320 may utilize reference values or thresholds to determine the presence of specific trends. For example, in identifying a sequential trend, the module may check if tasks consistently follow a predetermined sequence or if there are dependencies between tasks that require sequential execution. Similarly, for parallel trends, the task assessment module 320 may examine whether tasks can be executed simultaneously without affecting their outcomes. Dependency trends can be detected by assessing the relationships between tasks and determining if certain tasks are dependent on the completion of others. Frequency trends may involve analyzing the recurrence of certain tasks over time. Resource utilization trends can be identified by monitoring the allocation and consumption of resources for different tasks. Temporal trends may involve considering the timing or scheduling of tasks within the workflow. User interaction trends may be inferred from user behavior or input. Performance trends may involve analyzing task completion times or efficiency metrics. Exception trends may be detected by monitoring deviations from expected workflow behavior or predefined conditions. By evaluating these factors, the task assessment module 320 can accurately identify trends within the workflow and utilize them to make informed decisions about task allocation and execution.

After analyzing the graph structure and generating the rewrite instructions, the task assessment module 320 may communicate the instructions to the processor 330. This communication may occur dynamically in real-time during traversal of the graph structure or once the traversal of the graph is complete, after the task assessment module 320 has gathered all relevant data necessary for making informed decisions regarding modifications or updates to nodes in the graph structure. The processor 330 may then execute the instructions, which involve modifying nodes in the graph structure to reflect the evaluation outcomes encoded within the instructions. For example, in a supply chain management system, if the lead time of a supplier exceeds a predefined threshold, graph rewrite instructions may trigger the rerouting of the supply chain by updating node relationships to switch to an alternative supplier with shorter lead times.

The task assessment module 320 has several additional configurations. Firstly, it may be configured to recursively traverse the network of nodes. During this traversal, it determines any required metadata associated with each node based on a specified “type” and ensures that the necessary metadata is provided before proceeding with evaluation. Additionally, the task assessment module 320 can automatically generate metadata needed for a task. This metadata can be obtained by generating a prompt to an artificial intelligence system or module, such as Chat GPT, using data from the node, such as metadata, dependencies, and parent nodes, and then parsing the resulting information. Furthermore, the task assessment module 320 can automatically generate metadata by estimating it from another artificial intelligence architecture or automated process, based on available contextual data like previous task executions. Subsequently, the task assessment module 320 aggregates the automatically generated metadata to determine the required resources for task execution. The task assessment module 320 can further aggregate this metadata and suggest resource allocation before executing a task, or allow task execution only upon the allocation of those resources.

The processor 330 may include various logic circuitry, such as arithmetic logic units (ALUs), registers, and control units. The processor 330 may be implemented as a processor in a computer or mobile device, such as a smartphone or tablet. The processor 330 can adjust its operations based on predefined conditions to identify the most effective paths for executing tasks.

The processor 330 may interface with or connect to CPUs, GPUs, or various units for parallel computing, generating precise task execution instructions, monitoring performance, and orchestrating resource allocation. Additionally, the processor 330 may evaluate assessment outcomes, analyze task dependencies, resource availability, priority levels, temporal constraints, data dependencies, and user preferences for more efficient task execution. Within the system, the processor 330 may execute nodes in the graph structure, adjusting connections, adding or removing nodes, and updating properties as per the received instructions. For instance, if instructed to prioritize or defer a task based on resource availability, the processor 330 may rearrange the graph structure by updating dependencies or altering task sequences. In this regard, the processor 330 can dynamically optimize task execution paths to meet predefined conditions and user preferences.

The user interface 340 may be configured as an application on either a computer or a mobile device, such as a smartphone or tablet. Its functionality may include organizing task lists based on priority, due date, or project, enabling users to have a clear overview of their tasks. Detailed task information like descriptions, due dates, assigned users, and attachments may also be accessible through the user interface 340, allowing users to edit task details directly. Additionally, users may prioritize tasks within the list using drag-and-drop functionality. Quick actions for common tasks, such as marking tasks as complete or setting reminders, may be accessible through various menus or buttons displayed via the user interface 340. The user interface 340 may allow for visual navigation through the tree structure thereby enabling users to access specific tasks and their subtasks. Real-time updates and adjustments to input arguments, like variables in task calculations, can be made through the user interface 340. Collaborative decision-making features such as voting and discussion threads that enable detailed conversations and informed decision-making may be displayed via the user interface 340. Moreover, the user interface 340 can integrate with external devices or services via an API to enable communication with third-party applications. For instance, it may be integrated with the device's calendar app to visualize tasks with due dates on a calendar view, facilitating effective schedule planning. In collaborative environments, users can share tasks, assign them to team members, and track progress through the user interface 340. Notifications for upcoming deadlines, task assignments, or changes to shared tasks that keep users informed can be displayed via the user interface 340. Additionally, the user interface 340 may be linked to the task assessment module 320 and processor 330, allowing users to monitor code execution progress in real-time and providing options to pause, resume, or cancel execution as needed.

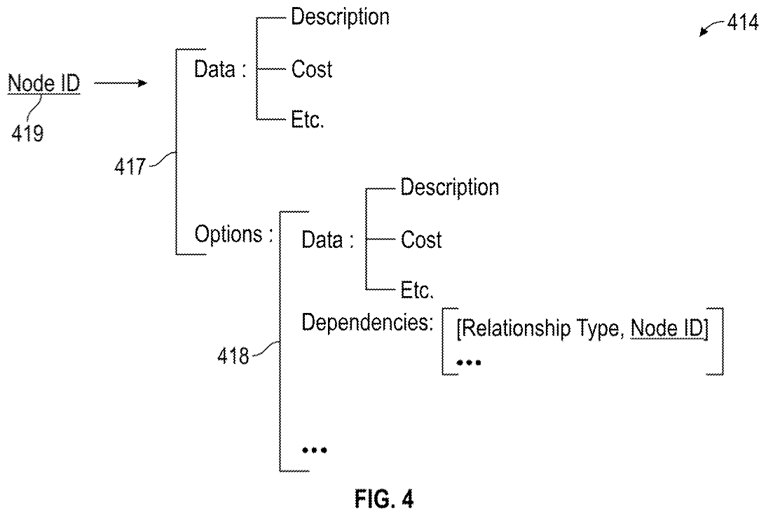

FIG. 4 representatively illustrates a data structure 414 of a node within a nodal network of a workflow optimization system, according to an embodiment. The data structure 414 may be configured to organize, link, and manage tasks efficiently within a workflow management system. Each node in the graph structure may contain metadata 417 and supplementary data 418. The metadata 417 may include various task details, including estimates of lines of code, programming language requirements, and dependencies on other tasks. Supplementary data 418 may include additional requirements such as completion time, currency specifications, material requisites, task dependencies, evaluator types, and other pertinent properties essential for task execution. These property requirements may be identified within the system by referencing a ‘type,’ which represents attributes characteristics associated with the tasks or nodes within the graph structure. Each property requirement, such as task dependencies or evaluator types, may be indicated by a designated type within the system For instance, a type may specify the required programming language for a task, while another type may indicate the evaluator type necessary for assessment. By utilizing types, the system can effectively organize and manage task properties.

Moreover, each node may be assigned a unique node ID 419, which can be read by one or more algorithms to navigate task structures, identify critical dependencies, and prioritize tasks based on their interrelationships and priority levels. In complex workflow scenarios with intricate task interdependencies and varying priority levels, node IDs 419 may be beneficial for accurate tracking and prioritization. For instance, in a software development project, delays in tasks like designing the user interface (Task A) or coding the backend functionalities (Task B) may impact the testing phase (Task C). The node IDs 419 encode these dependencies to enable algorithms to assign higher priority to tasks like Task A and Task B in order ensure the timely completion of Task C.

The node IDs 419 may be encoded by assigning unique identifiers to each task node using alphanumeric strings or numerical values. Additionally, hierarchical structures or parent-child relationships may be utilized to accurately reflect task dependencies. For example, in a manufacturing environment, tasks like material sourcing (Task D), component assembly (Task E), and quality control (Task F) may have dependencies. By utilizing node IDs, algorithms may be configured to efficiently locate critical tasks, such as material sourcing, and address any delays to minimize their effects on subsequent tasks. For instance, if there's a delay in sourcing materials (Task D), the algorithm can identify this task using its unique node ID and take corrective actions to expedite the process, thereby preventing delays in downstream tasks like component assembly (Task E) and quality control (Task F). Additionally, if the metadata indicates longer lead times for certain materials, the algorithm can proactively allocate additional resources or adjust schedules to mitigate potential delays.

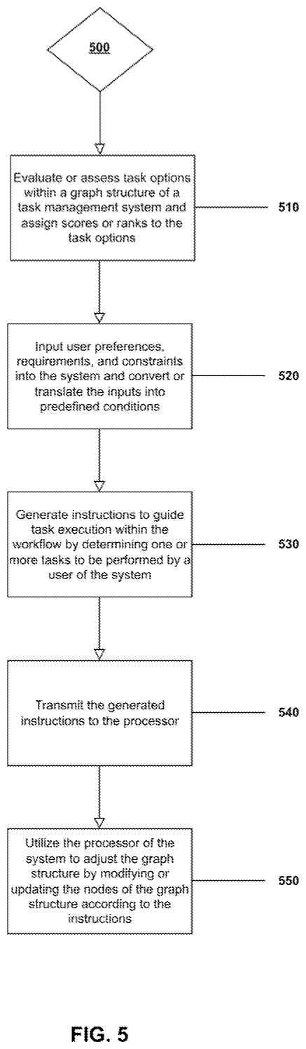

FIG. 5 illustrates a flow diagram (500) depicting the operation of an algorithm for determining an order for executing tasks within a workflow, based on predefined criteria, according to an embodiment. The algorithm may begin by assessing each task option or task dependency within a selected option or selected options and assigning scores or ranks to them, with higher scores indicating higher priority in the workflow (510). This assessment involves recursively traversing the nodes of the workflow graph and dynamically analyzing the metadata and supplementary data associated with each node against predefined conditions. These predefined conditions represent specific criteria or rules that dictate task prioritization and execution. Users input their preferences, requirements, and constraints into the system during the setup or configuration phase of the workflow management system, which are then translated into predefined conditions used by the algorithm during task evaluation (520). Tasks can be presented according to this priority, but still evaluated, executed, or provided with user input in any order. Upon that evaluation, execution, or user input of data, tasks which require that data may be allowed to continue execution or not depending on the user configuration of the task.

After completing the evaluation process, the algorithm generates instructions to guide task execution within the workflow by determining one or more tasks to be performed by a user of the system (530). The instructions may include recommendations for task prioritization, resource allocation, scheduling, and any other necessary actions to optimize workflow management. Once the instructions are generated, the instructions are transmitted to the processor (540). This communication may occur in real-time or after the algorithm has finished evaluating the tasks by traversing the entire graph structure, and the task assessment module has compiled all the relevant data needed for decision-making.

Upon receiving the instructions, the processor may adjust the graph structure by modifying or updating the nodes in the graph structure according to the instructions (550), such that the tasks are executed efficiently while also aligning with the workflow's objectives and priorities.

In an embodiment, one or more algorithms may be utilized to dynamically manage memory allocation within the workflow system. For instance, the one or more algorithms may allocate memory only when necessary and deallocate it when it is no longer needed, thereby minimizing memory usage and preventing memory leaks. For instance, during the evaluation of a task, the algorithm may allocate memory to store temporary data structures or intermediate results. Once the evaluation process concludes, the algorithm deallocates the memory to free up resources. The size of these data structures may depend on factors such as the complexity of the evaluation process and the amount of data being processed. By dynamically allocating memory for these data structures only when needed and deallocating it afterward, the algorithm optimizes memory usage.

The memory allocation for temporary data structures may be mathematically represented by the following formula:

Memory Allocation=Size of Data Structure*Number of Task Options

Where the Memory Allocation variable represents the total amount of memory that the algorithm dynamically allocates to store temporary data structures or intermediate results. The Size of Data Structure variable denotes the size in bytes of each individual data structure created by the algorithm. The size can vary depending on the type of data being stored and the complexity of the structure. The Number of Task Options variable represents the number of task options being evaluated by the algorithm at any given time. Each task option may require its own set of temporary data structures, and therefore, the total memory allocation depends on the number of options being evaluated.

For example, in the case where the algorithm is evaluating several task options within a workflow, each involving the calculation of intermediate results, if the size of the data structure required for each option is fixed at 100 bytes, and there are 10 task options being evaluated simultaneously, the total memory allocation would be 1000 bytes.

In this scenario, the algorithm would dynamically allocate 1000 bytes of memory to accommodate the temporary data structures needed for evaluating the task options. Once the evaluation process is complete, the algorithm deallocates this memory to free up system resources, thereby minimizing memory usage and preventing memory leaks. This dynamic memory management approach results in an efficient utilization of memory while optimizing the performance of the algorithm in evaluating task options within the workflow.

Additionally, the algorithm may utilize caching mechanisms to store frequently accessed data to reduce the need for repeated memory allocations. In tasks where caching mechanisms are used, the algorithm stores frequently accessed data in memory to avoid repeated computations or data retrieval operations. The size of the cached data and the number of cached entries determine the overall memory usage. By caching data in memory, the algorithm reduces the need for repeated memory allocations and improves the efficiency of task evaluation.

As an example, memory usage for caching mechanisms may be mathematically represented by the following formula:

Memory Usage=Size of Cached Data*Number of Cached Entries

Where the “Size of Cached Data” variable represents the amount of data stored in the cache, it refers to the total memory occupied by the cached information. For example, if the algorithm caches the results of database queries, the size of cached data would depend on the size of the query results stored in memory. If the query results include large datasets, the size of cached data would be significant. For instance, if the algorithm caches the results of image processing operations, and each processed image occupies 10 megabytes (MB) of memory, and there are 100 images cached, then the size of cached data would be 1000 MB.

The Number of Cached Entries variable may represent the count of individual items or entries stored in the cache. It indicates how many distinct pieces of data are being cached. For example, if the algorithm caches database query results, each query result would count as a separate entry in the cache. Continuing with the image processing scenario, if the algorithm caches the results of 100 different image processing operations, the number of cached entries would be 100.

By multiplying the size of cached data by the number of cached entries, the formula calculates the total memory usage attributed to the caching mechanism. This calculation helps in understanding and optimizing memory utilization within the system. Moreover, by storing frequently accessed data in memory, the algorithm reduces the need for repeated memory allocations, leading to improved efficiency in task evaluation and overall system performance.

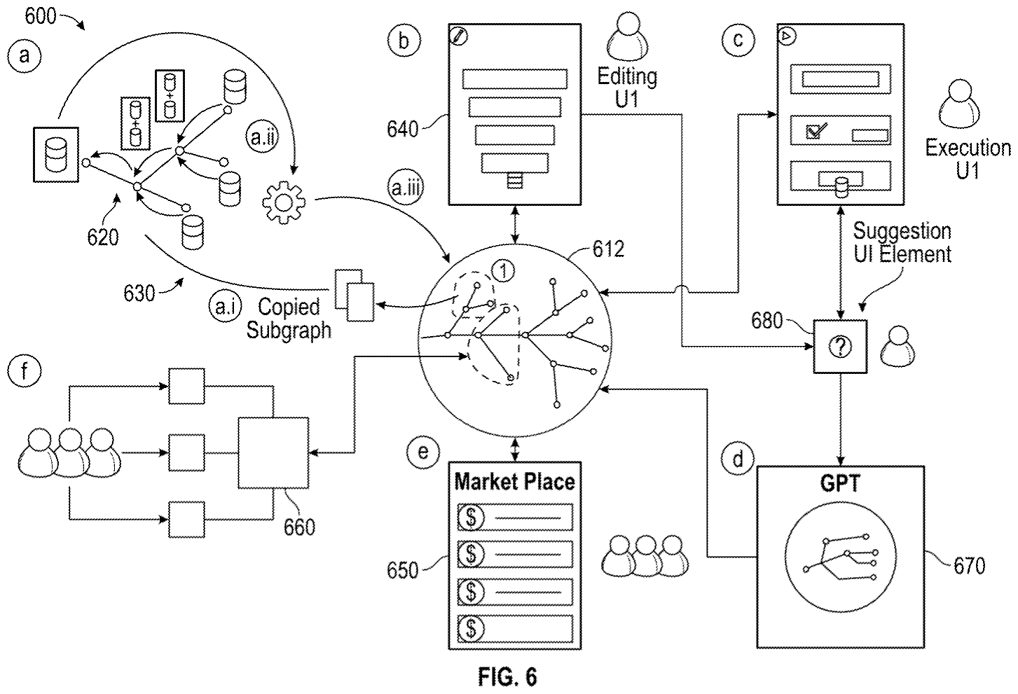

FIG. 6 representatively illustrates a task management system 600 including various components, according to an embodiment. The system 600 may include multiple components to manage decision-making and control flow mechanisms within a workflow. The system 600 may include a graph 612 structured as a tree to hierarchically organize tasks and processes. Users may interact with this structure through an editing user interface 640. The user interface 640 may be a platform configured for creating, modifying, or deleting nodes, defining task dependencies, and inputting relevant metadata according to user requirements and preferences.

Additionally, the system 600 may include a marketplace component 650 to facilitate collaborative bid analysis and selection among users. This component allows users to submit nodes with specific requirements, which are then evaluated by other users or evaluators who propose alternative solutions, such as different tasks to be performed or execution orders. In one embodiment, the marketplace component 650 may be integrated with the system's task assessment module 620 and processor 630. In another embodiment, the marketplace component 650 may be a separate component. The marketplace component 650 may be configured to operate with a task assessment module 620 and/or processor 630 to evaluate proposed solutions, alternative tasks, generate rewrite instructions based on predefined conditions and criteria or dynamically changing criteria obtained from the marketplace, and modify the graph according to the instructions.

Moreover, the system 600 may include a user interface 660 that enables users to initiate task execution within the workflow. Additionally, the user interface 660 may provide various functionalities for monitoring task performance, tracking progress, and receiving real-time updates on ongoing processes. Additionally, the system 600 may include an integrated AI language module, such as the GPT model 670, to provide, via a suggestion user interface 680, automated recommendations, text-based explanations, and decision-making computations based on the information stored in the graph. Furthermore, the system 600 may incorporate various automated project management tools, progress reports, and alerts to keep users informed about task statuses and deadlines. The system 600 may support both automated and manual review processes. Automation features like invoice generation based on executed tasks and resource usage, as well as report generation for analysis, may also be included. Feedback mechanisms, including backpropagation for neural networks, as well as metadata updates, payment distributions, and collective investment pool management systems, may be implemented within the system 600 to enhance workflow efficiency and collaboration among users.

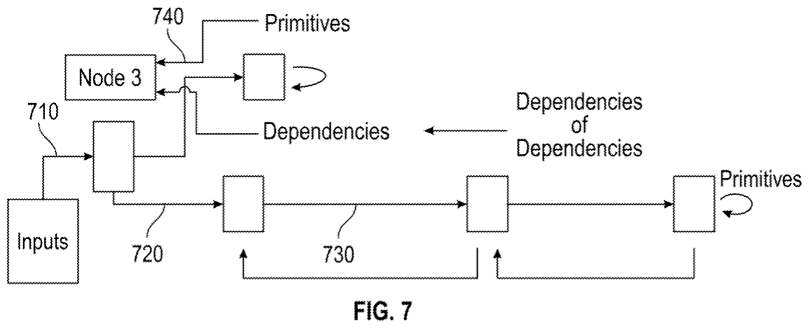

FIG. 7 is a flow diagram (700) for the evaluation of a node within a nodal network of a workflow optimization system, according to an embodiment. Specifically, FIG. 7 describes how an evaluation node (“eval node”) command works and explains how inputs are used. In the flow diagram depicted in FIG. 7, the “eval node” command is used to evaluate a node within a network of nodes, such as a tree structure. The evaluation process begins with the initiation of the “eval node” command, typically triggered by an external event or a specific condition within the system. The command identifies the target node within the tree structure that needs to be evaluated. This target node represents a specific task, process, or data element within the overall system. Before evaluating the target node, the command retrieves all necessary inputs required for the evaluation process (710). These inputs may include data dependencies, parameters, properties, or any other relevant information associated with the target node. Once the inputs are retrieved, the command initiates the evaluation process for the target node (720). This process may involve performing calculations, processing data, executing algorithms, or any other task associated with the functionality of the node. During the evaluation process, the inputs retrieved earlier are utilized to guide and inform the evaluation of the target node.

After the evaluation of the target node is complete, the computation results are propagated throughout the system as needed. This may involve updating other nodes within the tree structure, triggering subsequent actions or processes, or providing output to the user or other components of the system (730). Throughout the evaluation process, the command may include error handling mechanisms to address any issues or exceptions that arise. In this regard, each evaluation may be conducted to enable the system to handle unexpected situations without compromising the system's functionality. Lastly, once the evaluation of the target node is successfully completed, the “eval node” command concludes its execution, and the system transitions to the next phase of operation or awaits further instructions (740).

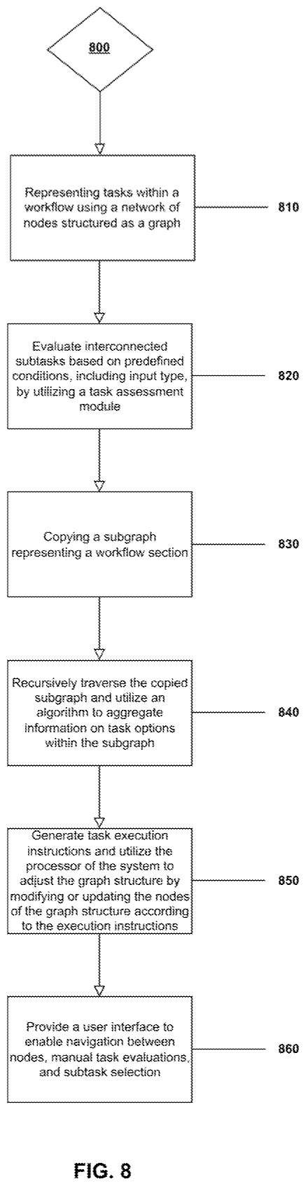

FIG. 8 depicts a flow diagram (800) illustrating a workflow optimization method, according to an embodiment. It provides a comprehensive overview of the steps involved in improving workflow efficiency.

Initially, the method involves representing tasks within the workflow using a network of nodes structured as a graph (810). Each node may represent interconnected subtasks associated with the respective task and includes relevant metadata for task execution. In this regard, the network of nodes may provide an organized overview of the workflow and its tasks.

Subsequently, the method may automatically or manually evaluate the interconnected subtasks based on predefined conditions, including input type, by utilizing a task assessment module (820). The task assessment module may analyze one or more portions of the graph (subgraphs) to assess their feasibility and priority within the workflow.

In an embodiment, the method may include copying a subgraph representing a workflow section (830). For example, in a software development workflow, the testing phase could be copied to optimize it while maintaining the original structure.

The method then recursively traverses through the copied subgraph (840). Starting from the initial task node, it explores each connected node, examining dependencies and alternative paths within the testing phase. Additionally, the method utilizes an algorithm to aggregate information on task alternatives. During traversal, the algorithm gathers data about task alternatives and variations within the subgraph. The method may generate task execution instructions by traversing the nodes, wherein traversing each node includes combining the predefined condition of each subtask associated with the node, combining the metadata, and performing a computation based on the predefined condition and metadata to generate a computation result. The method may also perform checks to ensure required metadata is available. If it is not, it may optionally use an artificial intelligence system or module, such as Chat GPT, to automatically generate required metadata, generate it via another automated process, or require the metadata to be input via a user interface. The system may halt execution of any tasks depending on that node until this information is provided. Additionally, the method may include allocating a resource provided in the user input by comparing an available resource to a threshold amount for executing a first task associated with the node, such that if the available resource is less than the threshold amount, the method refrains from performing the task. If the available resource is greater than the threshold amount, the method may revert an unused portion of the available resource to the node and allocate the unused portion of the available resource to a second task associated with a second node. The method may further include transferring metadata from a previously traversed node to the node it is currently evaluating. This process may be repeated for each node in the network of nodes.

The method described in the instant application may generate a new subgraph based on the aggregated information. This generated subgraph may reflect optimized pathways or configurations within the testing phase. The system may use predefined conditions to assess the feasibility and priority of tasks and generate the new subgraph based on this. For instance, the system may differentiate between urgent and non-urgent tasks, analyze input type conditions, and adjust priorities in real-time for overdue tasks.

Following the evaluation process, the method generates task execution instructions (860) such that tasks are performed in the correct order and sequence while considering dependencies and priority levels.

Furthermore, the method may provide a user interface enabling navigation between nodes, manual task evaluations, and subtask selection (850) to enhance decision-making throughout the workflow lifecycle.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A system, comprising:
a computational platform configured to communicate with an external device, wherein the computational platform comprises:
a network of nodes stored in memory, wherein each node in the network of nodes represents a task to be performed by a user within a workflow, and wherein each node contains:
one or more interconnected subtasks associated with their respective node; and
metadata;
a task assessment module configured to automatically or manually evaluate the interconnected subtasks based on a predefined condition and generate instructions based on the evaluation;
a user interface configured to present the network of nodes to the user and receive a user input for evaluating the one or more interconnected subtasks; and
a processor configured to determine at least one task to be performed by the user according to the instructions, user input, or metadata.

2. The system of claim 1, wherein:
the instructions are generated based on a type associated with the user input; and
the type associated with the user input comprises a human evaluator, an automatic evaluator, or a group evaluator received from the external device.

3. The system of claim 1, wherein the task assessment module is further configured to:
recursively traverse the network of nodes;
select metadata from each node to be used for evaluating the network of nodes based on a type of each node;
analyze the selected metadata associated with each node to identify a trend within the workflow; and
utilize an algorithm to determine at least one task to be performed by the user in the workflow based on the identified trend and metadata.

4. The system of claim 1, wherein the task assessment module is further configured to:
automatically generate the metadata based on contextual data or receive the metadata by initiating a prompt via the user interface connected to an artificial intelligence system;
parse the metadata;
aggregate the automatically generated metadata to determine an available resource; and
allocate the available resource or determine a resource allocation prior to executing a task associated with a node.

5. The system of claim 3, wherein the trend comprises a sequential trend, parallel trend, dependency trend, frequency trend, resource utilization trend, temporal trend, user interaction trend, performance trend, or exception trend.

6. A device, comprising:
a computational platform, comprising:
a network of nodes representing tasks within a workflow, wherein each node comprises:
one or more interconnected subtasks associated with their respective node; and
metadata; and
a task assessment module configured to evaluate the interconnected subtasks based on a task execution variable and generate instructions based on the evaluation;
a user interface configured to present the network of nodes to the user and receive a user input for evaluating the interconnected subtasks or their respective node; and
a processor configured to execute the instructions provided by the task assessment module or the user input to determine at least one task to be performed by a user in the workflow in accordance with a task execution order.

7. The device of claim 6, wherein at least one interconnected subtask represents an alternative task for performing the task associated with the node.

8. The device of claim 6, wherein the interconnected subtasks represent a chronological sequence of tasks for performing the task associated with the node.

9. The device of claim 6, wherein the performance of a first task associated with a first node is dependent on the performance of a second task associated with a second node within the network of nodes, and wherein:
the performance of a first interconnected subtask associated with the first node is dependent on the performance of a second subtask associated with the first node; or
the performance of the first interconnected subtask associated with the first node is dependent on the performance of a third subtask associated with the second node.

10. The device of claim 6, wherein the processor is further configured to:
establish a dependency between a first task and a second task based on the task execution variable; and
dynamically adjust the task execution order by modifying a position of the first task relative to the second task in response to a change in the task execution variable according to the user input.

11. The device of claim 10, wherein the task execution variable comprises a temporal constraint, a resource requirement, a user-defined priority, or a task dependency.

12. A method, comprising:
representing tasks within a workflow using a network of nodes, wherein each node comprises:
one or more interconnected subtasks associated with their respective node;
and
metadata;
evaluating, via a task assessment module, the interconnected subtasks based on a predetermined variable and a user input;
generating instructions for task execution based on the evaluation of the nodes;
executing the instructions using a processor to determine at least one task to be performed by a user in the workflow; and
providing a user interface to receive the user input and display the network of nodes.

13. The method of claim 12, further comprising generating rewrite instructions based on a type associated with the user input, wherein the type associated with the user input comprises a human evaluator, an automatic evaluator, or a group evaluator.

14. The method of claim 13, further comprising:
copying a first portion of the network of nodes representing a section of a workflow;
recursively traversing through the copied first portion of the network of nodes;
utilizing an algorithm to aggregate information pertaining to subtasks within the copied first portion of the network of nodes; and
generating a second portion of the network of nodes based on the aggregated information by dynamically adjusting the first portion of the network of nodes according to the rewrite instructions.

15. The method of claim 12, further comprising:
generating task execution instructions by traversing the nodes, wherein traversing each node comprises:
combining the predetermined variable of each subtask associated with the node;
combining the metadata;
performing a computation based on the predetermined variable and metadata to generate a computation result;
allocating a resource provided in the user input by comparing an available resource to a threshold amount for executing a first task associated with the node, wherein:
if the available resource is less than the threshold amount, refraining from performing the task;
if the available resource is greater than the threshold amount, reverting an unused portion of the available resource to the node; and
allocating the unused portion of the available resource to a second task associated with a second node; and
transferring metadata from a previously traversed node to the node.

16. The method of claim 12, further comprising:
executing a first subtask of a first node prior to a second subtask of the first node; or
executing a first parent task associated with the first node prior to executing a second parent task associated with a second node.

17. The method of claim 12, wherein:
the interconnected subtasks represent alternative tasks for completing a task;
each interconnected subtask represents a plurality of dependent tasks for performing the task; and
each dependent task is defined by an address of a node associated therewith and a relationship between the dependent task and the node.

18. The method of claim 15, wherein, at each node, traversing the node further comprises:
determining if the computation result is already stored in a cache memory;
retrieving the computation result if it is not cached;
storing the retrieved computation result in the cache memory; and
continuing traversal of the nodes within the network of nodes by utilizing the computation result to allocate the available resource to the node.

19. The method of claim 15, wherein allocating the resource comprises automatically allocating the available resource among the first task or second task within the workflow using the processor or manually allocating the available resource among the first task or second task using the user interface.

20. The method of claim 15, wherein the predetermined variable comprises a requirement, computational requirement, schedule requirement, cost requirement, spatial requirement, geographic requirement, personnel requirement, or machine requirement.
